(19) United States
(12) Patent Application Publication
(10) Pub. No.: US 2011/0173524 A1
(43) Pub. Date: Jul. 14, 2011

(54) Digital Media Bookmarking Comprising Source Identifier

(75) Inventors: Yuk Chan, Poughkeepsie, NY (US); Roan Dawkins, Poughkeepsie, NY (US); Saheem Granados, Poughkeepsie, NY (US); Jessie Yu, Poughkeepsie, NY (US)

(73) Assignee: INTERNATIONAL BUSINESS MACHINES CORPORATION, Armonk, NY (US)

(21) Appl. No.: 12/685,087

(22) Filed: Jan. 11, 2010

(51) Int. Cl. G06F 17/00

(52) U.S. Cl. 715/206

(57) ABSTRACT

A method for bookmarking digital media includes receiving bookmark content by a digital media device, the bookmark content corresponding to an instance of digital media; determining a source identifier corresponding to the instance of digital media by the digital media device; and storing the bookmark content and the source identifier in a digital media bookmark on the digital media device. A digital media device for bookmarking digital media is configured to receive bookmark content, the bookmark content corresponding to an instance of digital media located on the digital media device, the digital media device further configured to determine a source identifier corresponding to the instance of digital media, and to store the bookmark content and the source identifier in a digital media bookmark.

### BACKGROUND

This disclosure relates generally to the field of digital media bookmarking.

Digital media may take many forms, including but not limited to digital magazines, music, audio books, news, or video. A user may download a digital media file to a digital media device from a server connected to the Internet, and playback the digital media on a digital media device. A user may wish to provide feedback in the form of bookmarks at specific locations in the digital media file. However, if the digital media is viewed or played in a handheld or mobile digital media device, the user may not be permitted to create bookmarks, or, if bookmarking is permitted, the bookmarks may only be viewed on the digital media device on which they were created. This limits the use of the bookmarks. For example, if two bookmarks are created in the same digital media on two different digital media devices, a user may be required to view the bookmarks separately on the two digital media devices.

### SUMMARY

An exemplary embodiment of a method for bookmarking digital media includes receiving bookmark content by a digital media device, the bookmark content corresponding to an instance of digital media; determining a source identifier corresponding to the instance of digital media by the digital media device; and storing the bookmark content and the source identifier in a digital media bookmark on the digital media device.

An exemplary embodiment of a digital media device for bookmarking digital media is configured to receive bookmark content, the bookmark content corresponding to an instance of digital media located on the digital media device, the digital media device further configured to determine a source identifier corresponding to the instance of digital media, and to store the bookmark content and the source identifier in a digital media bookmark.

An exemplary embodiment of a computer program product comprising a computer readable storage medium containing computer code that, when executed by a computer, implements a method for digital media bookmarking, wherein the method includes receiving bookmark content, the bookmark content corresponding to an instance of digital media; determining a source identifier corresponding to the instance of digital media; and storing the bookmark content and the source identifier in a digital media bookmark.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an embodiment of bookmarked digital media.

FIG. 2 illustrates an embodiment of a digital media bookmark comprising a source identifier.

FIG. 3 illustrates an embodiment of a method for digital media bookmarking comprising a source identifier.

FIG. 4 illustrates an embodiment of a method for digital media bookmarking comprising a source identifier.

FIG. 5 illustrates an embodiment of a computer that may be used in conjunction with systems and methods for digital media bookmarking using a source identifier.

### DETAILED DESCRIPTION

Embodiments of systems and method for digital media bookmarking comprising a source identifier are provided, with exemplary embodiments being discussed below in detail. A digital media bookmark comprising voice or text information may be associated with an instance of digital media by storing the digital media bookmark in the same file as the digital media, or in a separate file that contains a source identifier corresponding to the digital media. The source identifier may comprise checksum validation logic that allows unique mapping of the digital media bookmark to the digital media file. A digital media bookmark comprising a source identifier may be transferred to or from the digital media's originating server, or between digital media devices. The digital media bookmarks may also be merged across devices or users. Digital media bookmarks may be used for ranking, tagging, or commentary purposes.

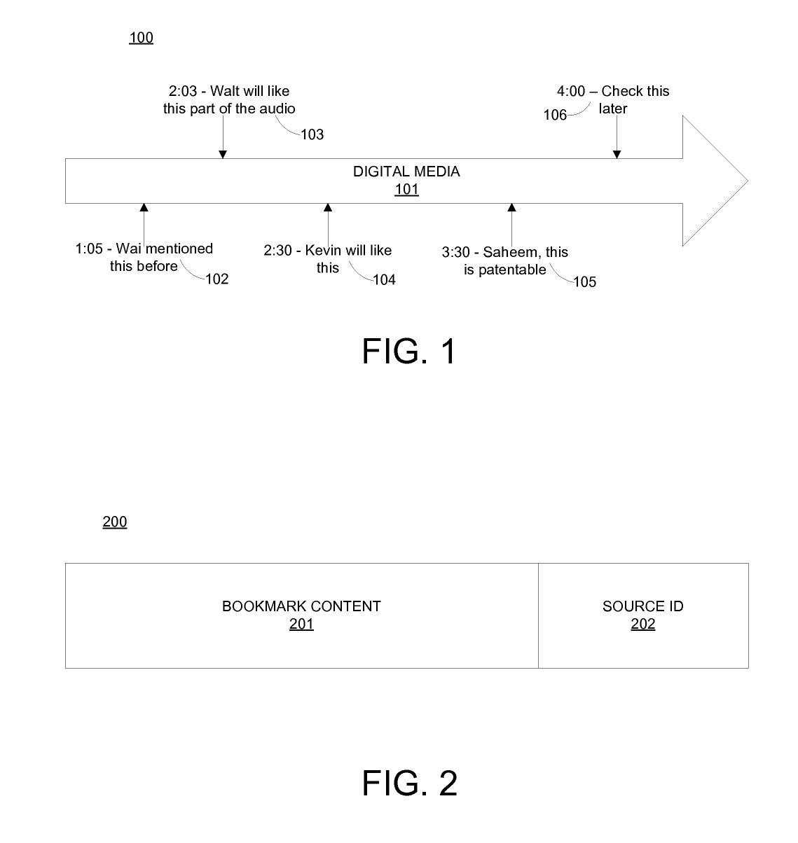

FIG. 1 illustrates an embodiment of bookmarked digital media 100. Bookmarked digital media 100 comprises digital media 101 and bookmarks 102-106. Digital media 101 may comprise any digital audio or video media. Digital media 101 may be played on any appropriate digital media device. Each of bookmarks 102-106 comprises a digital media bookmark 200 comprising a source identifier, as is shown in FIG. 2.

FIG. 2 illustrates an embodiment of a digital media bookmark 200. Digital media bookmark 200 comprises bookmark content 201 and source identifier 202. Bookmark content 201 and source identifier 202 are stored together in digital media bookmark 200. Bookmark content 201 may comprise voice or text information. For example, in the case of bookmark 102 of FIG. 1, bookmark content 201 comprises “Wai mentioned this before”. Source identifier 202 comprises a unique identifier corresponding to digital media 101. Source identifier 202 may comprise a constant, or may comprise a checksum derived from digital media 101. In embodiments in which source identifier 202 comprises a checksum, if digital media 101 is altered, source identifier 202 may not be used to identify the altered digital media. Source identifier 202 may further comprise an identification of the specific location of a digital media bookmark 200 in digital media 101. For example, in the case of bookmark 102 of FIG. 1, source identifier 202 may comprise “1:05”. Digital media bookmark 200 is shown for illustrative purposes only; a digital media bookmark may comprise any appropriate additional information, and the information comprising digital media bookmark 200 may be stored in any order in the digital media bookmark 200.

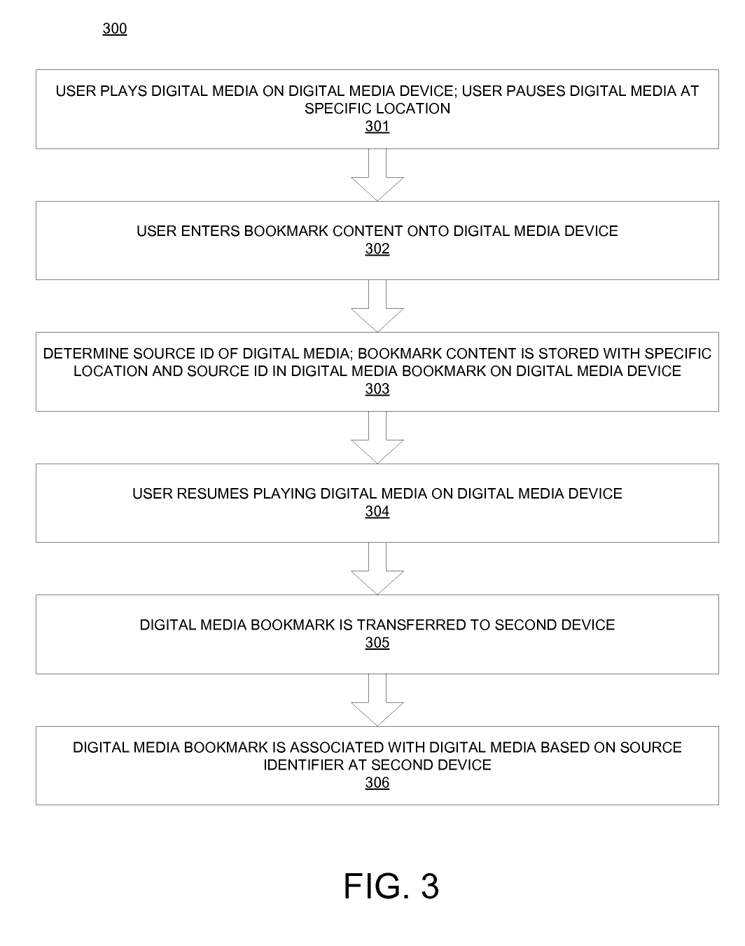

FIG. 3 illustrates an embodiment of a method 300 for digital media bookmarking using a source identifier. In block 301, digital media that is playing on a digital media device is paused at a specific location. In block 302, the user enters bookmark content into the digital media device. The bookmark content may comprise voice or text content. Voice content may be entered using any appropriate voice recording means, or text content may be entered using any appropriate text entry means. In embodiments in which a digital media bookmark comprising voice content is created, the voice information may be converted to text information using any appropriate voice-to-text technology. Digital media bookmarks comprising text information may be used for searching purpose on a text-capable device. In block 303, a source identifier for the digital media is determined. The source identifier may comprise a constant, or may comprise a checksum derived from the digital media. The digital media bookmark, comprising the bookmark content, the specific location in the digital media, and the determined source identifier of the digital media, is stored on the digital media device. In block 304, the user resumes playing the digital media on the digital media device.

In block 305, the digital media bookmark is transferred from the digital media device to a second device, which may include but is not limited to a server connected to the internet, a website, another digital media device, or any computer storage device. The digital media bookmark may be transferred in conjunction with the digital media, or independently from the digital media. In block 306, the digital media bookmark is identified to the digital media at the second device based on the source identifier. Identification of the digital media associated with the digital media bookmark based on the source identifier may be used in conjunction with merging of digital media bookmarks, as is described in U.S. patent application Ser. No. 12/571,871, to Chan et al., filed on Oct. 1, 2009, which is herein incorporated by reference in its entirety.

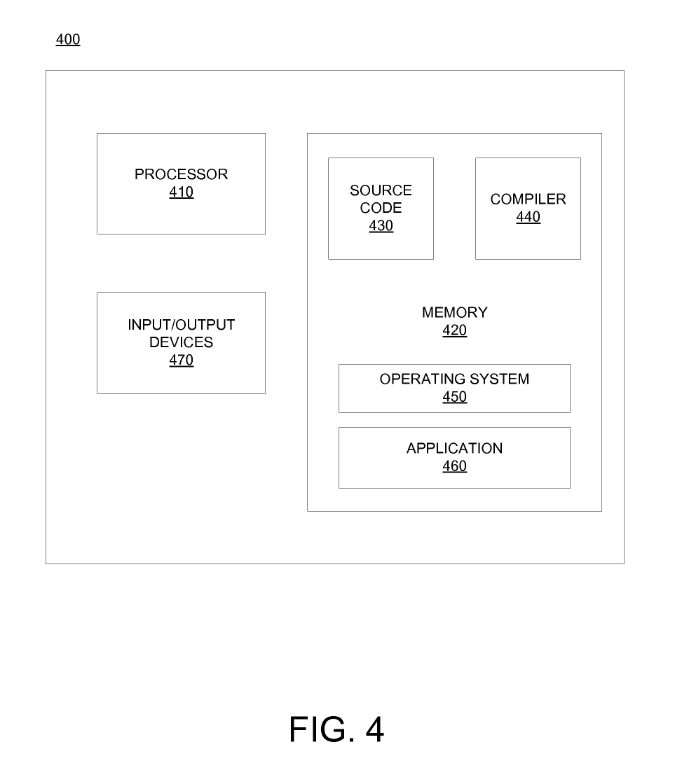

FIG. 4 illustrates an example of a computer 400 which may be utilized by exemplary embodiments of systems and method for digital media bookmarking comprising source identifier as embodied in software. Various operations discussed above may utilize the capabilities of the computer 400. One or more of the capabilities of the computer 400 may be incorporated in any element, module, application, and/or component discussed herein, including but not limited to a digital media device.

The computer 400 includes, but is not limited to, PCs, workstations, laptops, PDAs, palm devices, servers, storages, and the like. Generally, in terms of hardware architecture, the computer 400 may include one or more processors 410, memory 420, and one or more input and/or output (I/O) devices 470 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 410 is a hardware device for executing software that can be stored in the memory 420. The processor 410 can be virtually any custom made or commercially available processor, a central processing unit (CPU), a digital signal processor (DSP), or an auxiliary processor among several processors associated with the computer 400, and the processor 410 may be a semiconductor based microprocessor (in the form of a microchip) or a macroprocessor.

The memory 420 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in the memory 420 may include one or more separate programs, each of which comprises an ordered listing of executable instructions for implementing logical functions. The software in the memory 420 includes a suitable operating system (O/S) 450, compiler 440, source code 430, and one or more applications 460 in accordance with exemplary embodiments. As illustrated, the application 460 comprises numerous functional components for implementing the features and operations of the exemplary embodiments. The application 460 of the computer 400 may represent various applications, computational units, logic, functional units, processes, operations, virtual entities, and/or modules in accordance with exemplary embodiments, but the application 460 is not meant to be a limitation.

The operating system 450 controls the execution of other computer programs, and provides scheduling, input-output control, file and data management, memory management, and communication control and related services. It is contemplated by the inventors that the application 460 for implementing exemplary embodiments may be applicable on all commercially available operating systems.

Application 460 may be a source program, executable program (object code), script, or any other entity comprising a set of instructions to be performed. When a source program, then the program is usually translated via a compiler (such as the compiler 440), assembler, interpreter, or the like, which may or may not be included within the memory 420, so as to operate properly in connection with the O/S 450. Furthermore, the application 460 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 470 may include input devices such as, for example but not limited to, a mouse, keyboard, scanner, microphone, camera, etc. Furthermore, the I/O devices 470 may also include output devices, for example but not limited to a printer, display, etc. Finally, the I/O devices 470 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 470 also include components for communicating over various networks, such as the Internet or intranet.

If the computer 400 is a PC, workstation, intelligent device or the like, the software in the memory 420 may further include a basic input output system (BIOS) (omitted for simplicity). The BIOS is a set of essential software routines that initialize and test hardware at startup, start the O/S 450, and support the transfer of data among the hardware devices. The BIOS is stored in some type of read-only-memory, such as ROM, PROM, EPROM, EEPROM or the like, so that the BIOS can be executed when the computer 400 is activated.

When the computer 400 is in operation, the processor 410 is configured to execute software stored within the memory 420, to communicate data to and from the memory 420, and to generally control operations of the computer 400 pursuant to the software. The application 460 and the O/S 450 are read, in whole or in part, by the processor 410, perhaps buffered within the processor 410, and then executed.

When the application 460 is implemented in software it should be noted that the application 460 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 460 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 460 is implemented in hardware, the application 460 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include identification of the source digital media of a digital media bookmark across multiple devices or locations.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for bookmarking digital media, the method comprising:
receiving bookmark content by a digital media device, the bookmark content corresponding to an instance of digital media;
determining a source identifier corresponding to the instance of digital media by the digital media device; and
storing the bookmark content and the source identifier in a digital media bookmark on the digital media device.

2. The method of claim 1, wherein the bookmark content comprises voice content.

3. The method of claim 2, further comprising converting the voice content to text content.

4. The method of claim 1, wherein the bookmark content comprises text content.

5. The method of claim 1, further comprising transferring the digital media bookmark to a second device.

6. The method of claim 5, further comprising identifying the instance of digital media based on the source identifier stored in the digital media bookmark at the second device.

7. The method of claim 1, wherein the source identifier comprises a constant.

8. The method of claim 1, wherein the source identifier comprises a checksum.

9. A digital media device for bookmarking digital media, the digital media device configured to receive bookmark content, the bookmark content corresponding to an instance of digital media located on the digital media device, the digital media device further configured to determine a source identifier corresponding to the instance of digital media, and to store the bookmark content and the source identifier in a digital media bookmark.

10. The digital media device of claim 9, wherein the bookmark content comprises voice content.

11. The digital media device of claim 9, wherein the bookmark content comprises text content.

12. The digital media device of claim 9, wherein the source identifier comprises a constant.

13. The digital media device of claim 9, wherein the source identifier comprises a checksum.

14. A computer program product comprising a computer readable storage medium containing computer code that, when executed by a computer, implements a method for digital media bookmarking, wherein the method comprises:
receiving bookmark content, the bookmark content corresponding to an instance of digital media;
determining a source identifier corresponding to the instance of digital media; and
storing the bookmark content and the source identifier in a digital media bookmark.

15. The computer program product according to claim 14, wherein the bookmark content comprises voice content.

16. The computer program product according to claim 14, wherein the bookmark content comprises text content.

17. The computer program product according to claim 14, further comprising transferring the digital media bookmark to a second device.

18. The computer program product according to claim 14, further comprising identifying the instance of digital media based on the source identifier stored in the digital media bookmark at the second device.

19. The computer program product according to claim 14, wherein the source identifier comprises a constant.

20. The computer program product according to claim 14, wherein the source identifier comprises a checksum.
